(19) United States
(12) Patent Application Publication
(10) Pub. No.: US 2026/0037876 A1
(43) Pub. Date: Feb. 5, 2026

(54) NON-TRANSITORY COMPUTER-READABLE RECORDING MEDIUM, LEARNING METHOD, INFERENCE METHOD, AND INFORMATION PROCESSING APPARATUS

(71) Applicant: Fujitsu Limited, Kawasaki-shi (JP)

(72) Inventors: Masahiro KATAOKA, Kamakura (JP); Ryo MATSUMURA, Numazu (JP); Yasushi FUJII, Meguro (JP); Satoshi ONOUE, Yokohama (JP); Mayumi KIDO, Fukuoka (JP); Hiromi KOGA, Fukuoka (JP)

(73) Assignee: Fujitsu Limited, Kawasaki-shi (JP)

(21) Appl. No.: 19/356,244

(22) Filed: Oct. 13, 2025

Related U.S. Application Data
(63) Continuation of application No. PCT/JP2023/015686, filed on Apr. 19, 2023.

(51) Int. Cl. G06N 20/00

(52) U.S. Cl. CPC G06N 20/00

(57) ABSTRACT

A non-transitory computer-readable recording medium has stored therein a learning program that causes a computer to execute a process including acquiring teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other and executing machine learning of a machine learning model based on the teacher data.

### CROSS-REFERENCE TO RELATED APPLICATION(S)

This application is a continuation application of International Application No. PCT/JP2023/015686, filed on Apr. 19, 2023, the entire contents of which are incorporated herein by reference.

### FIELD

The embodiment discussed herein is related to a computer-readable recording medium and the like.

### BACKGROUND

Receptors are regulatory proteins present in cells and selectively receive various signaling molecules. The receptors are mainly embedded in a plasma membrane, but are also present in the cytoplasm and on the nuclear surface. Signaling molecules combined with receptors to induce biological responses are called “ligands”.

Substances serving as ligands include hormones, some amino acids, neurotransmitters, toxins, drugs, or the like. Ligands are known to selectively or specifically exhibit high affinity for specific sites on the receptor. In many cases, different receptors may be present for each ligand, and combinations of ligands and receptors that can be combined with each other vary greatly depending on the cell type.

Both protein conformational and chemical characterization studies are underway to infer combinations of receptors and ligands that can be combined.

The higher-order structure of a protein such as a receptor is public data and includes a sequence of about 20 types of amino acids. FIG. 13A is a diagram illustrating an example of the relationship between names and abbreviations/symbols of amino acids. For example, the abbreviation and symbol for the amino acid “alanine” are “Ala” and “A”. The relationship among names and abbreviations/symbols of other amino acids is illustrated in FIG. 13A.

An amino acid is a compound in which an amino group (—NH₂) and a carboxyl group (—COOH) are bonded to a carbon (C), and FIG. 13B illustrates the general structural formula of an amino acid. FIG. 13B is a diagram illustrating an example of the relationship between the general structural formula and side chains of the chemical structural formula of amino acids. In addition, a “side chain (R)” is bonded to the central carbon (C), and the type of amino acid varies depending on this difference. FIG. 13B illustrates the specific side chains (R) of “alanine” and “valine” and chemical structural formulas thereof.

In the related art, a machine learning model is used to determine whether the combination of a receptor and a ligand is an appropriate combination (whether they can be combined with each other).

FIG. 14 is a diagram (1) for explaining the related art. With reference to FIG. 14, the process of a learning phase in the related art is described. For convenience of description, a device that executes the related art is referred to as a “conventional device”. The conventional device executes machine learning of a machine learning model M1 by using sets of input data and correct answer labels.

For example, the input data includes a plurality of chemical structural formulas 5 for a receptor and each atom thereof, and a chemical structural formula 6 for a ligand to be combined with the receptor and each atom thereof. The chemical structural formula 5 for the receptor includes 5-1, 5-2, and 5-3. The correct answer label is set with information on whether the receptor and the ligand of the input data can be combined with each other.

The conventional device uses a vector dictionary to calculate vectors vc5-1, vc5-2, and vc5-3 of the plurality of chemical structural formulas 5-1, 5-2, and 5-3 for the receptor based on the vector of each atom thereof. The conventional device uses the vector dictionary to calculate a vector vc6 of the chemical structural formula 6 based on the vector of each atom thereof. The conventional device calculates a vector vc7 that is the product of the vectors vc5-1, vc5-2, and vc5-3 and the vector vc6.

The conventional device inputs the vector vc7 to the machine learning model M1 to obtain an output result 8. The conventional device updates parameters of the machine learning model so that the difference between the output result 8 and the correct answer label is reduced.

The conventional device trains the machine learning model M1 by repeatedly executing the above process on other sets of input data and correct answer labels.

FIG. 15 is a diagram (2) for explaining the related art. With reference to FIG. 15, the process of an inference phase in the related art is described. The conventional device uses the trained machine learning model M1 to infer whether a receptor and a ligand in candidate data can be combined with each other.

For example, the candidate data includes a plurality of chemical structural formulas 10 for the receptor and each atom thereof, and a chemical structural formula 11 for the ligand to be combined with the receptor. The chemical structural formula 10 for the receptor includes 10-1, 10-2, and 10-3.

The conventional device uses a vector dictionary to calculate vectors vc10-1, vc10-2, and vc10-3 of the chemical structural formulas 10-1, 10-2, and 10-3 based on the vector of each atom thereof. The conventional device uses the vector dictionary to calculate a vector vc11 of the chemical structural formula 11 based on the vector of each atom thereof. The conventional device calculates a vector vc12 that is the product of the vectors vc10-1, vc10-2, and vc10-3 and the vector vc11.

The conventional device inputs the vector vc12 to the trained machine learning model M1 to obtain an output result 13. When the output result 13 is “OK (combinable)”, the conventional device estimates that the combination of the receptor and the ligand in the candidate data is appropriate. On the other hand, when the output result 13 is “NG” (not combinable), the conventional device estimates that the combination of the receptor and the ligand in the candidate data is not appropriate. The related technologies are described, for example, in: Patent document 1: Japanese Laid-open Patent Publication No. 2019-028879; Patent document 2: U.S. Patent Application Publication No. 2022/0246233; Patent document 3: Japanese National Publication of International Patent Application No. 2018-503171; and Patent document 4: U.S. Patent Application Publication No. 2017/0323049.

For example, whether a receptor and a ligand can be combined with each other is influenced not only by protein sequence information for chemical characterization, but also by coordinate information of atoms constituting the receptor and the ligand for conformational analysis. However, even though the receptor has a higher-order protein structure (a plurality of primary structures) and the ligand has a primary protein structure, the related art described above focuses on each atom in the chemical structural formula of an amino acid and has a problem in that the granularity and the amount of information for estimation are not optimal and it is not possible to appropriately estimate whether target receptor and ligand can be combined.

### SUMMARY

According to an aspect of an embodiment, a non-transitory computer-readable recording medium has stored therein a learning program that causes a computer to execute a process including acquiring teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other and executing machine learning of a machine learning model based on the teacher data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of protein structure data;

FIG. 2 is a diagram for explaining a process of a preprocessing phase;

FIG. 3 is a diagram illustrating an example of a Postscript program;

FIG. 4 is a diagram (1) for explaining a learning phase;

FIG. 5 is a diagram (2) for explaining a learning phase;

FIG. 6 is a diagram (1) for explaining an inference phase process;

FIG. 7 is a diagram (2) for explaining an inference phase process;

FIG. 8 is a functional block diagram illustrating a configuration of an information processing apparatus according to the present embodiment;

FIG. 9 is a flowchart illustrating a processing procedure of a preprocessing phase;

FIG. 10 is a flowchart illustrating a processing procedure of a learning phase;

FIG. 11 is a flowchart illustrating a processing procedure of an inference phase;

FIG. 12 is a diagram illustrating an example of a hardware configuration of a computer that implements the same functions as the information processing apparatus of an embodiment;

FIG. 13A is a diagram illustrating an example of the relationship between names and symbols of amino acids;

FIG. 13B is a diagram illustrating an example of the relationship between the general structural formula and side chains of the chemical structural formula of amino acids;

FIG. 14 is a diagram (1) for explaining the related art; and

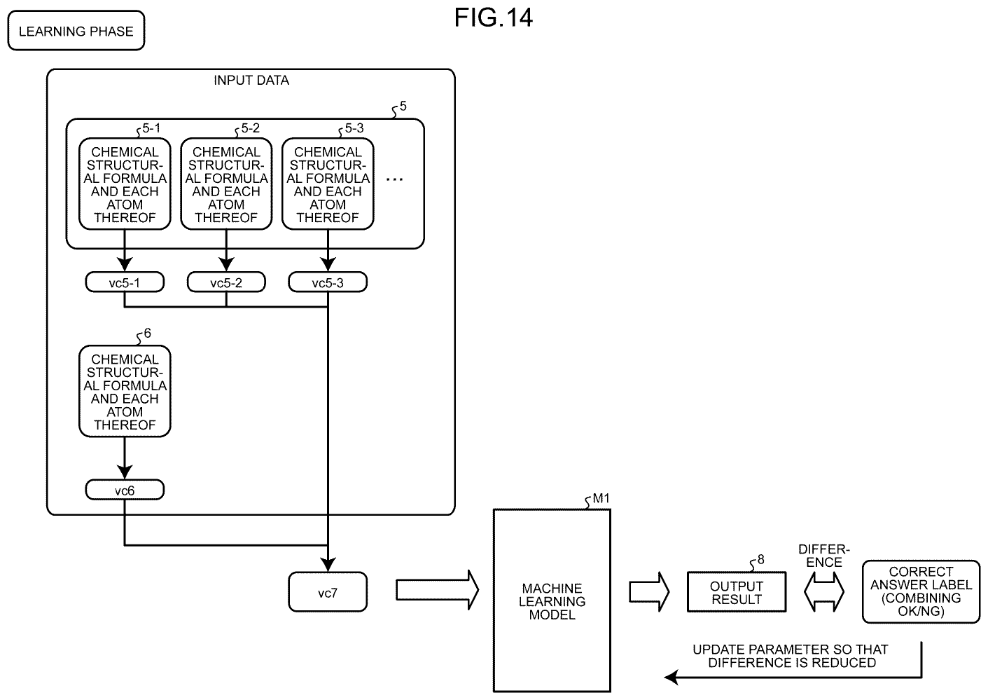

FIG. 15 is a diagram (2) for explaining the related art.

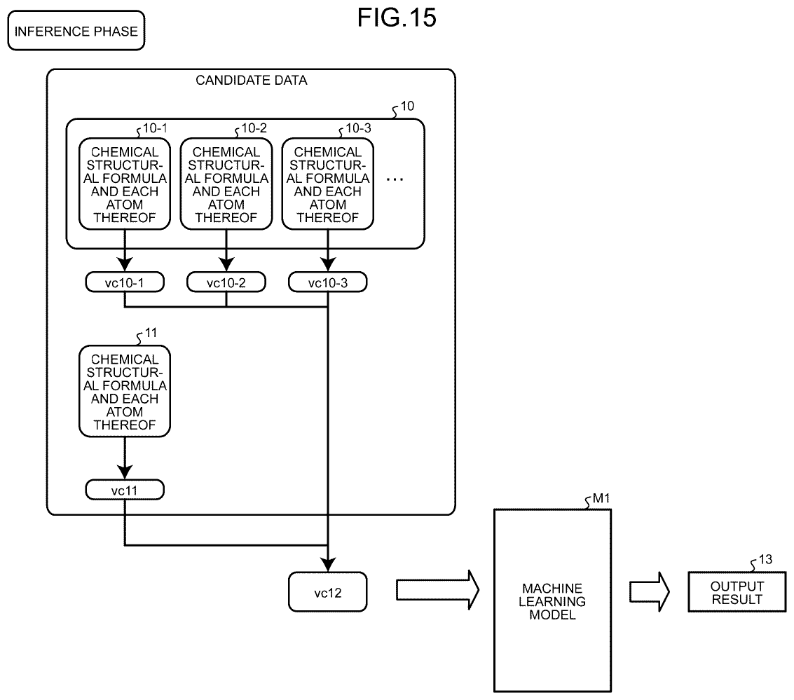

### DESCRIPTION OF EMBODIMENT(S)

Preferred embodiments of the present invention will be explained with reference to accompanying drawings. This invention is not limited by these embodiments.

Before describing the process of the information processing apparatus according to the present embodiment, an example of “protein structure data” handled by the information processing apparatus is described. The protein structure data can be obtained from a protein data bank (PDB).

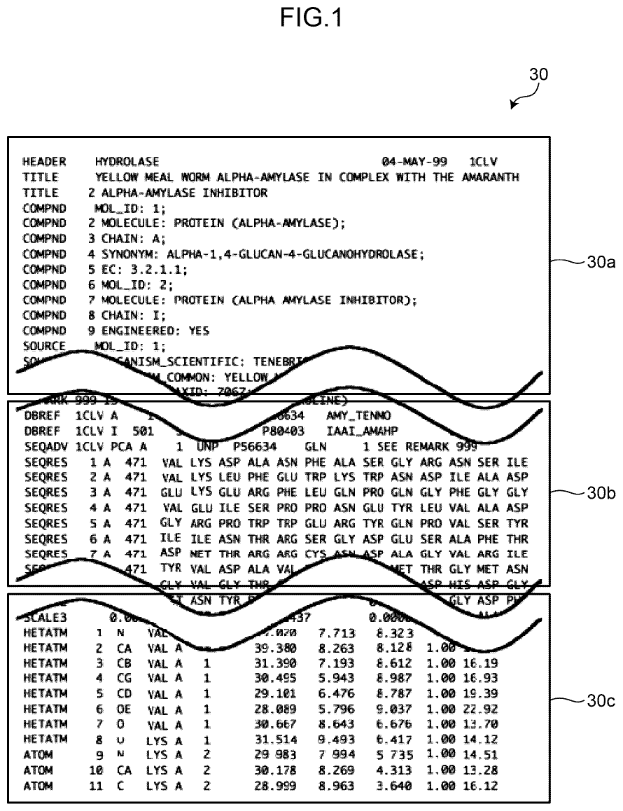

FIG. 1 is a diagram illustrating an example of protein structure data. For example, protein structure data 30 illustrated in FIG. 1 includes a header area 30a, a sequence information area 30b, and a coordinate information area 30c as protein structure information. The header area 30a is set with a molecular name and the like corresponding to a protein.

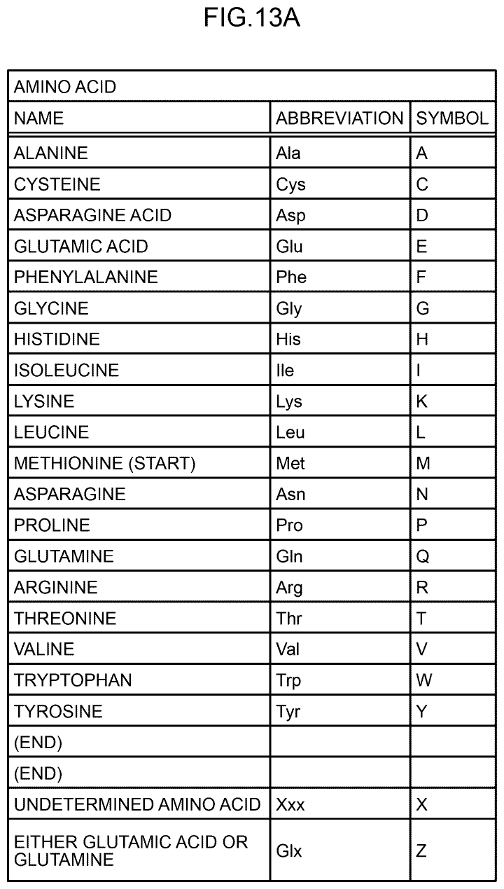

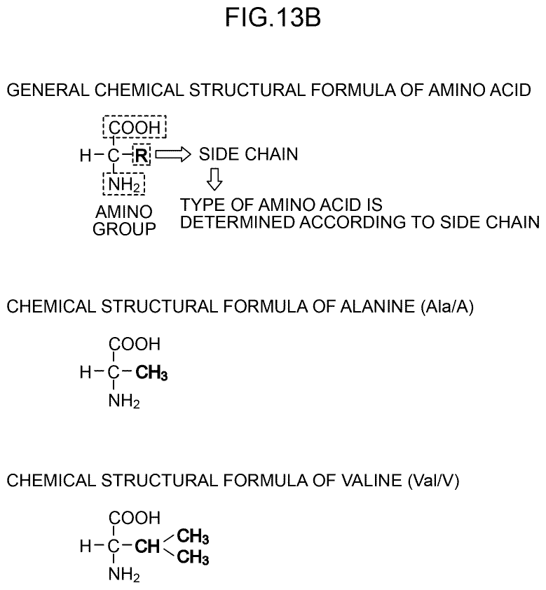

The sequence information area 30b is set with sequence information of amino acids included in the protein. The sequence information of amino acids is information in which the abbreviations (three letters) of the amino acids constituting the protein are arranged, as described with reference to FIG. 13A.

A sequence of a series of a plurality of amino acids in the protein structure data corresponds to a primary structure of the protein. Although the sequence of amino acids included in the primary structure has various patterns, in the present embodiment, the sequence of amino acids included in each primary structure is assumed to be predefined. A sequence of a plurality of consecutive primary structures corresponds to a higher-order structure of the protein. In the PDB, data may be stored in sequence information and coordinate information in a state in which a receptor and a ligand are with each other. For example, the protein structure data 30 includes a plurality of primary protein structures constituting the higher-order structure of the receptor and a primary protein structure constituting the ligand.

The coordinate information area 30c is set with the positions (three-dimensional coordinates) of a plurality of atoms constituting the amino acids included in the protein. In the present embodiment, the position of each atom constituting the amino acid included in the sequence information area 30b is assumed to be set in the coordinate information area 30c. In the present embodiment, attention is focused on given atoms among a plurality of atoms. For example, the given atoms are (1) An amino group “N”, (2) An atom located at the tip of the side chain of the central carbon (C) (for example, the amino acid valine “Val” is atom “C”), and (3) A carboxyl group “O”. In the following description, the given atoms to be focused are denoted as a first atom, a second atom, and a third atom. A plurality of first atoms may be present in one primary structure, and the positions of the first atoms may differ. The same is true for the second atom and the third atom.

By using the protein structure data of the receptor combined with the ligand as described above, the higher-order structure (a plurality of primary structures) of the receptor, the one-dimensional structure of the ligand, and the coordinate information of given atoms of the amino acids constituting the receptor and ligand can be specified.

Subsequently, a process of the information processing apparatus according to the present embodiment is described. The information processing apparatus according to the present embodiment sequentially executes a process of a preprocessing phase, a process of a learning phase, and a process of an inference phase. In the following description, the information processing apparatus according to the present embodiment is referred to as an “information processing apparatus 100”.

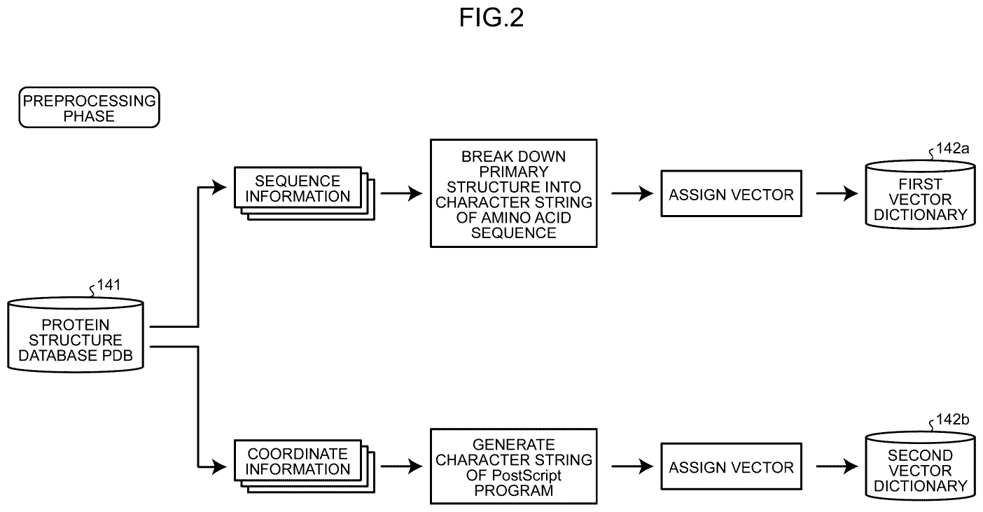

The process of the preprocessing phase executed by the information processing apparatus 100 is described. FIG. 2 is a diagram for explaining the process of the preprocessing phase. The information processing apparatus 100 generates a first vector dictionary 142a and a second vector dictionary 142b by executing the process of the preprocessing phase.

The information processing apparatus 100 has a protein structure database PDB 141. The protein structure database PDB 141 stores protein structure data corresponding to a plurality of proteins (receptors or receptors combined with ligands). The protein structure data has been described with reference to FIG. 1.

The process by which the information processing apparatus 100 generates the first vector dictionary 142a is described. The information processing apparatus 100 extracts a plurality of primary structures from each protein structure data in the protein structure database PDB 141. As described with reference to FIG. 1, information on the primary structure is stored in the sequence information area 30b.

In the description of FIG. 2, the plurality of primary structures (sequence information) are collectively referred to as a “primary structure 41”. As described with reference to FIG. 1, the primary structure is information on the character string of the amino acid sequence. The information processing apparatus 100 breaks down the primary structure 41 into the character string of the amino acid sequence.

The information processing apparatus 100 breaks down the primary structure 41 into character strings of a plurality of amino acid sequences (or functional group sequences of organic compounds), and then arranges the character strings of each primary structure in order. The information processing apparatus 100 applies CBoW and skip-gram (Word2vec) algorithms to each sequenced character string, and calculates a vector of each character string of a primary structure corresponding to a sentence, with each amino acid (or functional group) as a word. The information processing apparatus 100 registers the relationship between the character strings in a reference unit of the primary structure 41 and vectors in the first vector dictionary 142a. The information processing apparatus 100 may divide the primary structure 41 into predefined reference units.

By repeatedly executing the above process on other primary structures, the information processing apparatus 100 registers, in the first vector dictionary 142a, the relationship between character strings of amino acid sequences included in the other primary structures and vectors. The information processing apparatus may assign a vector using a unit of amino acids as the reference unit.

Subsequently, the process by which the information processing apparatus 100 generates the second vector dictionary 142b is described. The information processing apparatus 100 extracts coordinate information of the plurality of primary structures from each protein three-dimensional structure data in the protein structure database PDB 141. As described with reference to FIG. 1, the coordinate information of the primary structure is the information stored in the coordinate information area 30c and includes information on the positions of the first atom, the second atom, and the third atom of each amino acid. The coordinate information is an example of “structure information”.

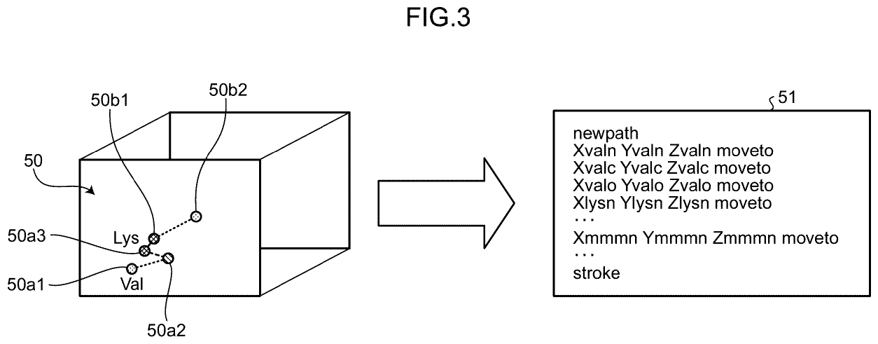

The information processing apparatus 100 generates a character string of a Postscript program that draws the shape of a three-dimensional line connecting the positions of the first atom, the second atom, and the third atom included in the coordinate information. FIG. 3 is a diagram illustrating an example of the Postscript program. For example, the example illustrated in FIG. 3 illustrates three-dimensional lines 50 with which a first atom 50a1, a second atom 50a2, and a third atom 50a3 of the amino acid valine “Val” are connected to one another. As illustrated in FIG. 3, the same atom may be present at a plurality of positions. For example, the information processing apparatus 100 may generate the three-dimensional lines 50 by repeatedly connecting the nearest atoms among a plurality of atoms.

The information processing apparatus 100 generates a Postscript program 51 that draws a three-dimensional line 50. The Postscript program 51 includes an instruction text (character string) for drawing the three-dimensional line 50. The information processing apparatus 100 may generate a Postscript program that projects a three-dimensional line onto a two-dimensional plane from a given direction and draws the line projected onto the two-dimensional plane.

Return to the description in FIG. 2. The information processing apparatus 100 executes morphological analysis on the Postscript program to break down the Postscript program into a plurality of morphemes (tokens). After breaking down the Postscript program into the plurality of tokens, the information processing apparatus 100 arranges the tokens in order. The information processing apparatus 100 applies the CBOW and skip-gram algorithms to each token arranged in order and computes a vector of each token with each token as a word. The information processing apparatus 100 registers the relationship between the tokens of the Postscript program and the vectors in the second vector dictionary 142b.

By repeatedly executing the above process on coordinate information of other primary structures, the information processing apparatus 100 registers, in the second vector dictionary 142b, the relationship between tokens of a Postscript program obtained from coordinate information of the other primary structures and vectors.

As described above, the information processing apparatus 100 generates the first vector dictionary 142a and the second vector dictionary 142b by executing the process of the preprocessing phase. The information processing apparatus 100 may acquire in advance, from an external device or the like, the first vector dictionary 142a that defines the relationship between the character strings of amino acid sequences and vectors, and the second vector dictionary 142b that defines the relationship between the tokens of the Postscript program and vectors. When the first vector dictionary 142a and the second vector dictionary 142b are acquired in advance, the information processing apparatus 100 may skip the process of the preprocessing phase.

The amino acid sequence of the primary structure of the protein is considered as the sentence of a text, and the symbol for each amino acid is considered as the word of the text, indicating how to generate a vector dictionary. In Japanese, hiragana such as “the”, “ni”, “wo”, and “ha” are words with meanings. About 20 types of amino acids also have chemical properties such as acidic, basic, neutral/hydrophilic, and neutral/hydrophobic. Words composed of a plurality of hiragana such as “ai (love)” and “ai (indigo)” also have unique meanings. Accordingly, by adding amino acid sequences called motifs, which constitute regular three-dimensional structures such as a-helices and B-sheets of proteins, to the vector dictionary, the accuracy of the vector dictionary can be improved.

In the above, the method for generating the vector dictionaries has been described for ligands of biomedicines composed of amino acid sequences. On the other hand, for organic compound pharmaceuticals composed of functional group sequences in the related art, chemical property analysis and three-dimensional structure analysis can be executed by generating a vector dictionary based on dozens of functional groups, calculated in the same manner as the amino acid sequences. As with the assignment of letters A to Z to about 20 types of amino acids, the method for assigning letters a to z and symbols such as “!” to the functional groups may also be applied.

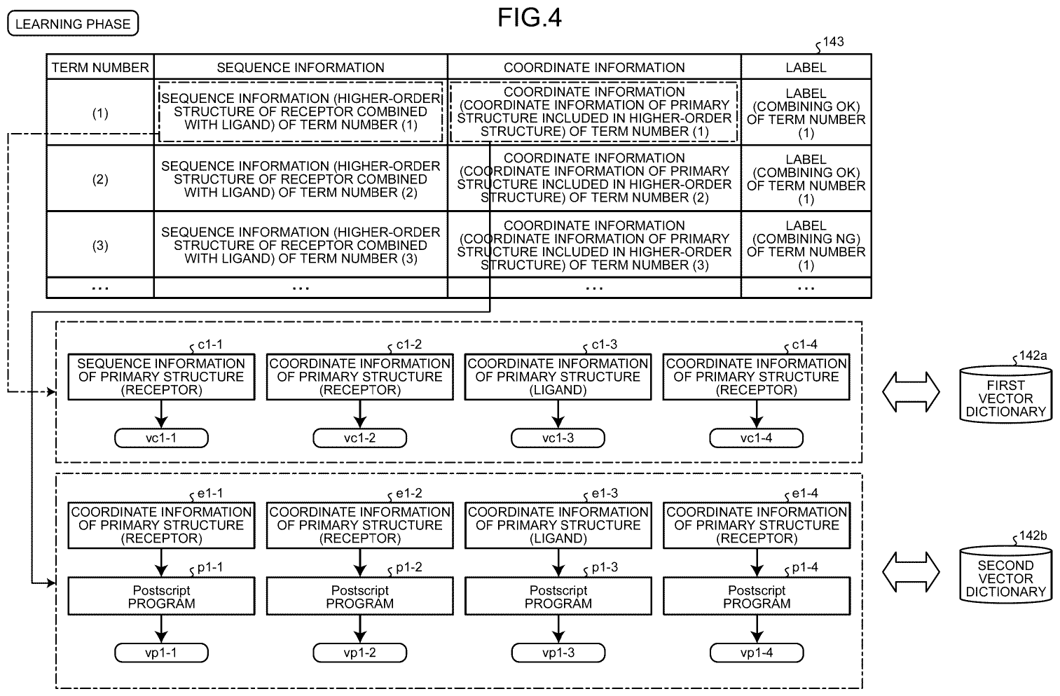

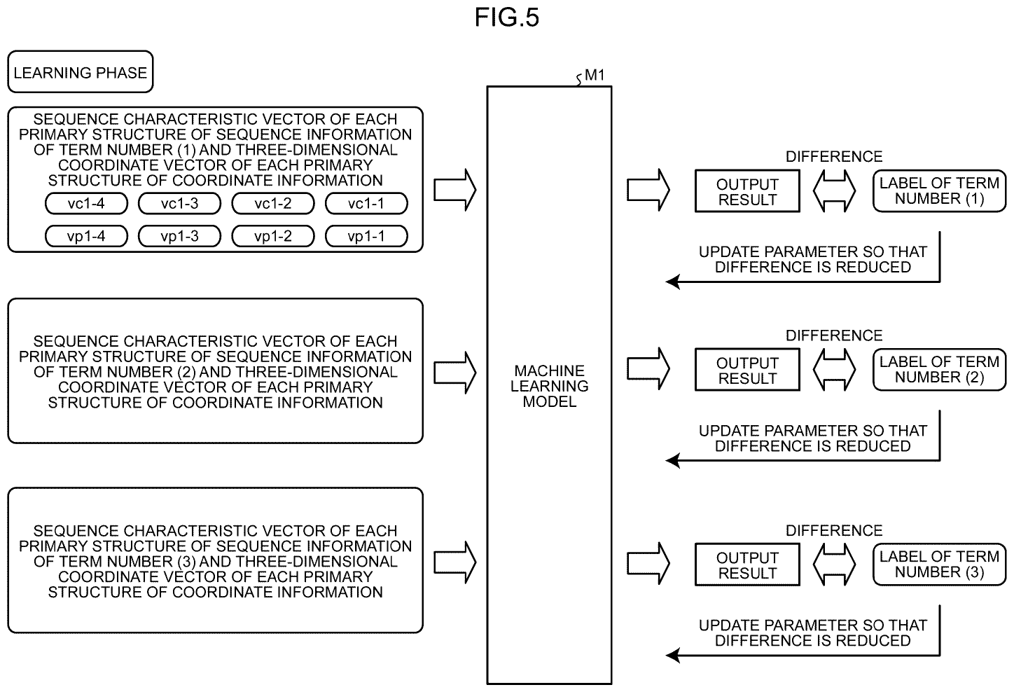

The process of the learning phase executed by the information processing apparatus 100 is described below. FIGS. 4 and 5 are diagrams for explaining the learning phase. The information processing apparatus 100 executes the process of the learning phase by using a teacher data table 143 prepared in advance.

FIG. 4 is described. For example, the teacher data table 143 associates term numbers, sequence information, coordinate information, and labels with one another. The term number is a number for identifying records (teacher data) in the teacher data table 143. The sequence information is the higher-order structure of a receptor combined with a ligand, and such a higher-order structure includes a series of a plurality of primary structures. The term number also enables to identify which primary structures, which constitute the higher-order structure of the receptor, are adjacent before and after the primary structure of the ligand in the combined state. The coordinate information is information indicating the positions of a first atom, a second atom, and a third atom of each amino acid in the plurality of primary structures included in the higher-order structure of the protein. Note that one piece of coordinate information is set for one primary structure. The label indicates whether the receptor combined with the ligand is appropriate. For example, when the receptor combined with the ligand is appropriate, the label is set with “OK <for example, 1>”. On the other hand, when the receptor combined with the ligand is not appropriate, the label is set with “NG <for example, 0>”.

For example, the sequence information of term number (1) includes primary structures c1-1, c1-2, c1-3, and c1-4 in order from the top. For example, among the primary structures c1-1, c1-2, c1-3, and c1-4, the primary structure c1-3 is the primary structure of the ligand.

The coordinate information of item (1) includes coordinate information e1-1, e1-2, e1-3, and e1-4 in order from the top. For example, the coordinate information e1-1 is information on the positions of a first atom, a second atom, and a third atom included in the primary structure c1-1. The coordinate information e1-2 is information on the positions of a first atom, a second atom, and a third atom included in the primary structure c1-2. The coordinate information e1-3 is information on the positions of a first atom, a second atom, and a third atom included in the primary structure c1-3. The coordinate information e1-4 is information on the positions of a first atom, a second atom, and a third atom included in the primary structure c1-4.

The information processing apparatus 100 calculates the vector of each primary structure for chemical property analysis by using the first vector dictionary 142a generated in a preparation phase. In the following description, the vector of the primary structure is denoted as a “sequence characteristic vector”.

The following description is given using the primary structure c1-1 included in the sequence information of the item (1). The information processing apparatus 100 breaks down the primary structure c1-1 into a character string in a reference unit (for example, a preset unit of atoms or a unit of atoms set in advance). The information processing apparatus 100 specifies the vector of each character string in the reference unit by comparing each character string in the reference unit of the primary structure c1-1 with the first vector dictionary 142a. The information processing apparatus 100 calculates a sequence characteristic vector vc1-1 of the primary structure c1-1 by adding up the vector of each character string in the reference unit.

The information processing apparatus 100 calculates a sequence characteristic vector vc1-2 of the primary structure c1-2 in the same way as for the primary structure c1-1. The information processing apparatus 100 calculates a sequence characteristic vector vc1-3 of the primary structure c1-3. The information processing apparatus 100 calculates a sequence characteristic vector vc1-4 of the primary structure c1-4.

Subsequently, the information processing apparatus 100 calculates the vector of each coordinate information by using the second vector dictionary 142b generated in the preparation phase. In the following description, a vector of the coordinate information is denoted as a “three-dimensional coordinate vector”.

The following description is given using the coordinate information e1-1 included in the coordinate information of the item (1). The information processing apparatus 100 generates a character string p1-1 of a Postscript program that draws the shape of a three-dimensional line connecting the positions of the first, second, and third atoms included in the coordinate information e1-1. The information processing apparatus 100 executes morphological analysis on the Postscript program p1-1 to break down the Postscript program p1-1 into a plurality of morphemes (tokens).

The information processing apparatus 100 specifies the vector of each token by comparing each token of the Postscript program p1-1 with the second vector dictionary 142b. The information processing apparatus 100 calculates a three-dimensional coordinate vector vp1-1 by adding up the vector of each token of the Postscript program p1-1.

The information processing apparatus 100 generates a Postscript program p1-2 for the coordinate information e1-2 in the same way as for the coordinate information e1-1, and calculates a three-dimensional coordinate vector vp1-2 based on the Postscript program p1-2 and the second vector dictionary 142b. The information processing apparatus 100 generates a Postscript program p1-3 for the coordinate information e1-3, and calculates a three-dimensional coordinate vector vp1-3 based on the Postscript program p1-3 and the second vector dictionary 142b. The information processing apparatus 100 generates a Postscript program p1-4 for the coordinate information e1-4, and calculates a three-dimensional coordinate vector vp1-4 based on the Postscript program p1-4 and the second vector dictionary 142b.

The description of FIG. 5 is given. The information processing apparatus 100 inputs sets of the sequence characteristic vectors of the sequence information and the three-dimensional coordinate vectors of the coordinate information for each primary structure of each term number in order to the machine learning model M1, and trains (updates parameters) the machine learning model M1 so that a value output from the machine learning model M1 approaches a corresponding label.

The machine learning model M1 is a neural network (NN) such as pre-training of deep bidirectional transformers for language understanding (BERT), next sentence prediction, or transformers.

A case in which the information processing apparatus 100 updates parameters by using the sequence information, the coordinate information, and the labels corresponding to the term number (1) in the teacher data table 143 is described.

The information processing apparatus 100 executes the process described with reference to FIG. 4 to calculate the sequence characteristic vectors vc1-1 to vc1-4 for each primary structure of the sequence information corresponding to the term number (1). The information processing apparatus 100 also calculates the three-dimensional coordinate vectors vp1-1 to 1-4 of the coordinate information corresponding to the term number (1).

The information processing apparatus 100 inputs sets of the sequence characteristic vectors of the sequence information and the three-dimensional coordinate vectors of the coordinate information to the machine learning model M1 in order. For example, the information processing apparatus 100 first inputs the sequence characteristic vector vc1-1 and the three-dimensional coordinate vector vp1-1 to the machine learning model M1. The information processing apparatus 100 secondly inputs the sequence characteristic vector vc1-2 and the three-dimensional coordinate vector vp1-2 to the machine learning model M1. The information processing apparatus 100 thirdly inputs the sequence characteristic vector vc1-3 and the three-dimensional coordinate vector vp1-3 to the machine learning model M1. The information processing apparatus 100 fourthly inputs the sequence characteristic vector vc1-4 and the three-dimensional coordinate vector vp1-4 to the machine learning model M1.

The information processing apparatus 100 updates the parameters of the machine learning model M1 so that the difference between an output result from the machine learning model M1 and the label of the term number (1) is reduced when the last set of the sequence characteristic vector of the primary structure and the three-dimensional coordinate vector of the coordinate information is input to the machine learning model M1.

The information processing apparatus 100 updates the parameters of the machine learning model M1 by repeatedly executing the same process as above on sequence information, coordinate information, and labels after term number (2) in the teacher data table 143.

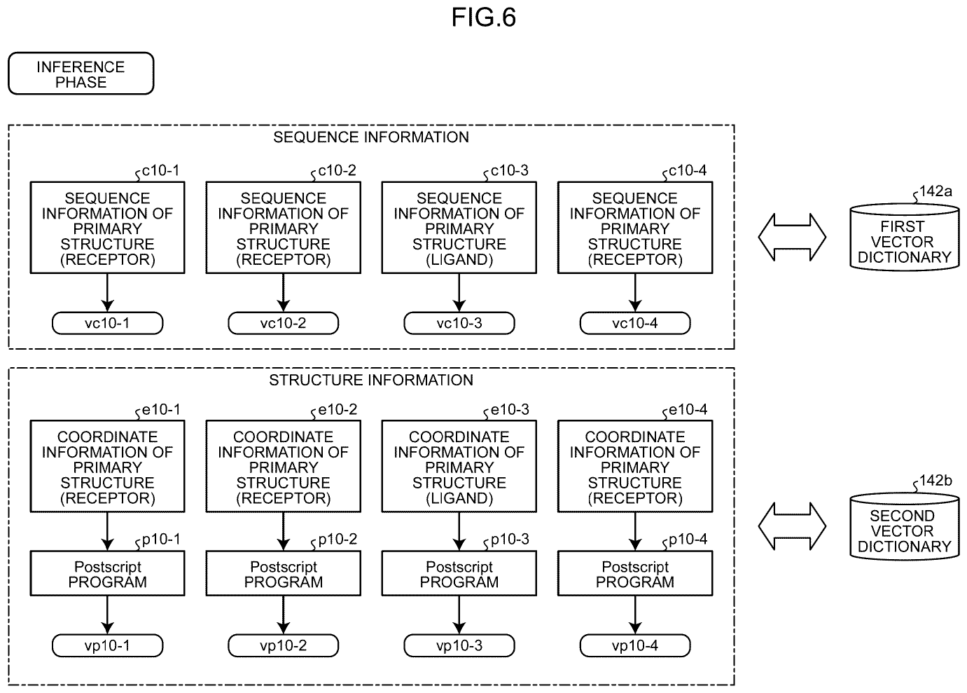

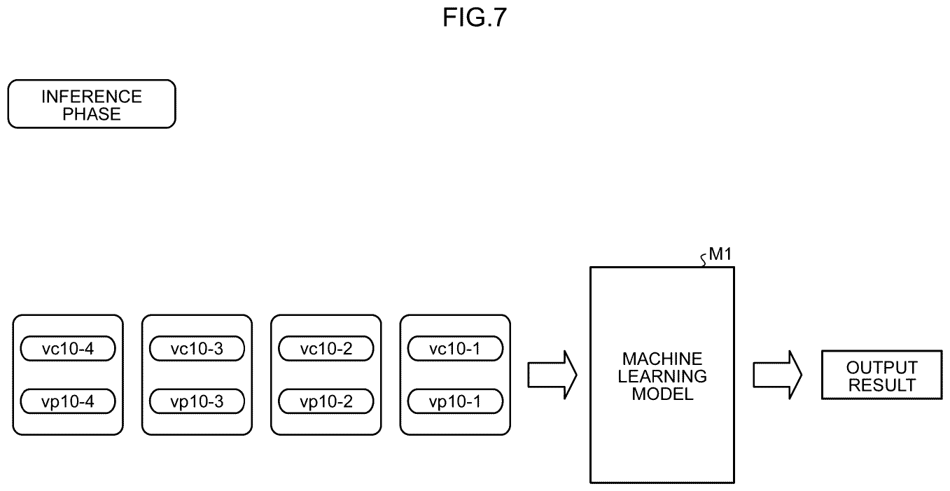

The process of the inference phase executed by the information processing apparatus 100 is described below. FIGS. 6 and 7 are diagrams for explaining the process of the inference phase. First, FIG. 6 is described. The information processing apparatus 100 receives, from a user, sequence information and coordinate information of a certain receptor that is the target of inference and that has combined with a certain ligand.

For example, the sequence information includes primary structures c10-1, c10-2, c10-3, and c10-4 from the top. For example, among the primary structures c10-1, c10-2, c10-3, and c10-4, the primary structure c10-3 is the primary structure of the ligand.

The coordinate information includes coordinate information e10-1, e10-2, e10-3, and e10-4 in order from the top. For example, the coordinate information e10-1 is information on the positions of a first atom, a second atom, and a third atom included in the primary structure c10-1. The coordinate information e10-2 is information on the positions of a first atom, a second atom, and a third atom included in the primary structure c10-2. The coordinate information e10-3 is information on the positions of a first atom, a second atom, and a third atom included in the primary structure c10-3. The coordinate information e10-4 is information on the positions of a first atom, a second atom, and a third atom included in the primary structure c10-4.

The information processing apparatus 100 uses the first vector dictionary 142a to calculate sequence characteristic vectors vc10-1, vc10-2, vc10-3, and vc10-4 of the primary structures c10-1, c10-2, c10-3, and c10-4. The process by which the information processing apparatus 100 calculates the sequence characteristic vectors of the primary structure by using the first vector dictionary 142a is the same as the process described in the learning phase.

Subsequently, the information processing apparatus 100 generates Postscript programs p10-1, p10-2, p10-3, and p10-4 based on the coordinate information e10-1, e10-2, e10-3, and e10-4. The process by which the information processing apparatus 100 generates the Postscript programs based on the coordinate information is the same as the process described in the learning phase.

The information processing apparatus 100 uses the second vector dictionary 142b to calculate three-dimensional coordinate vectors vp10-1, vp10-2, vp10-3, and vp10-4 of the Postscript programs p10-1, p10-2, p10-3, and p10-4. The process by which the information processing apparatus 100 calculates the three-dimensional coordinate vectors by using the second vector dictionary 142b is the same as the process described in the learning phase.

The description of FIG. 7 is given. The information processing apparatus 100 inputs sets of the sequence characteristic vectors vc10-1 to vc10-4 of the sequence information and the three-dimensional coordinate vectors vp10-1 to vp10-4 of the coordinate information, as described with reference to FIG. 6, to the machine learning model M1 in order.

For example, the information processing apparatus 100 first inputs the sequence characteristic vector vc10-1 and the three-dimensional coordinate vector vp10-1 to the machine learning model M1. The information processing apparatus 100 secondly inputs the sequence characteristic vector vc10-2 and the three-dimensional coordinate vector vp10-2 to the machine learning model M1. The information processing apparatus 100 thirdly inputs the sequence characteristic vector vc10-3 and the three-dimensional coordinate vector vp10-3 to the machine learning model M1. The information processing apparatus 100 fourthly inputs the sequence characteristic vector vc10-4 and the three-dimensional coordinate vector vp10-4 to the machine learning model M1.

The information processing apparatus 100 acquires an output result from the machine learning model M1 when the last set of the sequence characteristic vector of the primary structure and the three-dimensional coordinate vector of the coordinate information is input to the machine learning model M1. For example, the machine learning model M1 of the present embodiment may output a score indicating the certainty of combining OK.

When the score of the output result is equal to or greater than a threshold (combining OK), the information processing apparatus 100 estimates that the receptor indicated in the sequence information in FIG. 6 and combined with the ligand is appropriate (the sequence of the series of primary structures of the receptor is also appropriate). On the other hand, when the score of the output result is less than the threshold (combining NG), the information processing apparatus 100 estimates that the receptor indicated in the sequence information in FIG. 6 and combined with the ligand is not appropriate.

As described above, in the learning phase, the information processing apparatus 100 executes machine learning of the machine learning model based on teacher data associating input data including sequence information of a plurality of primary structures and coordinate information of the plurality of primary structures with labels, the plurality of primary structures being included in a higher-order structure of a receptor combined with a ligand, the label indicating whether the receptor and the ligand can be combined with each other. This allows the generation of the machine learning model M1 to appropriately estimate whether target receptor and ligand can be combined with each other.

The information processing apparatus 100 inputs, to the trained machine learning model M1, data including sequence information of a plurality of primary structures and coordinate information of the plurality of primary structures, the plurality of primary structures being included in a higher-order structure of a receptor combined with a target ligand. The information processing apparatus 100 can use output results to estimate whether the receptor combined with the ligand is appropriate. In the present embodiment, whether the sequence of a plurality of primary structures of the receptor (including the primary structure of the ligand) is also appropriate can also be further determined.

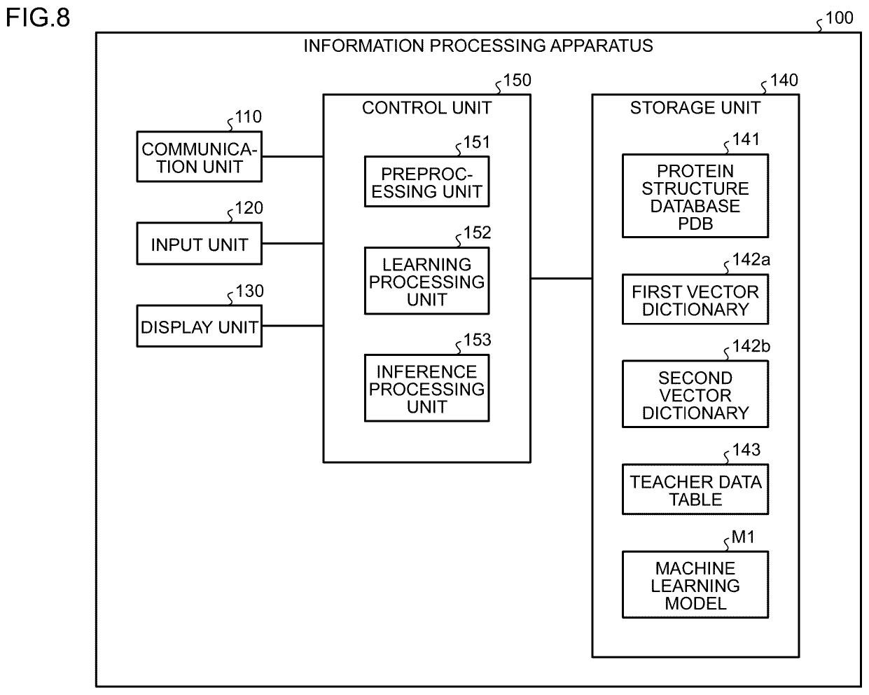

Subsequently, an example of the configuration of the information processing apparatus 100 that executes the process of the inference phase, the process of the learning phase, and the process of the inference phase. FIG. 8 is a functional block diagram illustrating the configuration of the information processing apparatus according to the present embodiment. As illustrated in FIG. 8, the information processing apparatus 100 includes a communication unit 110, an input unit 120, a display unit 130, a storage unit 140, and a control unit 150.

The communication unit 110 is connected to the external device or the like by wire or wirelessly, and transmits and receives information to and from the external device or the like. The communication unit 110 is implemented by a network interface card (NIC) or the like. The communication unit 110 may be connected to a network (not illustrated). The communication unit 110 may receive information on the protein structure database PDB 141, the first vector dictionary 142a, and the second vector dictionary 142b from the external device, and register the received information in the storage unit 140.

The input unit 120 is an input device that inputs various information to the information processing apparatus 100. The input unit 120 corresponds to a keyboard, a mouse, a touch panel, or the like. For example, during the inference phase, a user may operate the input unit 120 to input sequence and coordinate information to be inferred.

The display unit 130 is a display device that displays information output from the control unit 150. The display unit 130 corresponds to a liquid crystal display, an organic electroluminescence (EL) display, a touch panel, or the like. For example, the display unit 130 displays estimation results of an estimation phase by the control unit 150.

The storage unit 140 includes the protein structure database PDB 141, the first vector dictionary 142a, the second vector dictionary 142b, the teacher data table 143, and the machine learning model M1. The storage unit 140 is implemented, for example, by a semiconductor memory element such as a random access memory (RAM) and a flash memory, or a storage device such as a hard disk or an optical disk.

The protein structure database PDB 141 stores protein structure data corresponding to a plurality of proteins (receptors or receptors combined with ligands). The description regarding the protein structure database PDB141 is the same as the description given with reference to FIG. 2.

The first vector dictionary 142a is a dictionary that holds character strings in basic units of a primary structure and vectors in association with each other. Other descriptions regarding the first vector dictionary 142a are the same as the descriptions regarding the first vector dictionary 142a illustrated in FIG. 2 and the like.

The second vector dictionary 142b is a dictionary that holds tokens of Postscript programs generated from the coordinate information and vectors in association with each other. Other descriptions regarding the second vector dictionary 142b are the same as the descriptions regarding the second vector dictionary 142b illustrated in FIG. 2 and the like.

The teacher data table 143 holds a plurality of teacher data. The teacher data associates sequence information, coordinate information, and labels with one another. Each of the teacher data is used when machine learning is executed on the machine learning model M1. The description regarding the data structure of the teacher data table 143 is the same as the description regarding the data structure of the teacher data table 143 illustrated in FIG. 4.

The machine learning model M1 is NN such as BERT, next sentence prediction, or transformers described with reference to FIG. 5.

The control unit 150 includes a preprocessing unit 151, a learning processing unit 152, and an inference processing unit 153. The control unit 150 is implemented, for example, by a central processing unit (CPU) or a micro processing unit (MPU). The control unit 150 may also be implemented, for example, by an integrated circuit such as an application specific integrated circuit (ASIC) or a field programmable gate array (FPGA).

The preprocessing unit 151 executes the process of the preprocessing phase described with reference to FIG. 2 and the like. The preprocessing unit 151 acquires the protein structure data from the protein structure database PDB 141, and acquires a plurality of primary structures and coordinate information corresponding to each primary structure from the protein structure data.

The preprocessing unit 151 breaks down the primary structure into character strings in a plurality of reference units (for example, amino acid sequences), and applies the CBOW and skip-gram (Word2vec) algorithms to assign a vector to each character string. The preprocessing unit 151 sets the relationship between the character strings and the vectors in the first vector dictionary 142a.

The preprocessing unit 151 generates a Postscript program that draws the shape of a three-dimensional line connecting the positions of a first atom, a second atom, and a third atom included in the coordinate information. The preprocessing unit 151 executes morphological analysis on the Postscript program to break down the Postscript program into a plurality of morphemes (tokens). The preprocessing unit 151 applies the CBoW and skip-gram (Word2vec) algorithms, assigns a vector to each token, and sets the relationship between the tokens of the Postscript program and the vectors in the second vector dictionary 142b.

The description regarding the other processes in the preprocessing unit 151 is the same as the description regarding the process of the preprocessing phase described with reference to FIGS. 2 and 3. When the first vector dictionary 142a and the second vector dictionary 142b have been acquired in advance, the preprocessing unit 151 may skip the process of the preprocessing phase.

The learning processing unit 152 executes the process of the learning phase described with reference to FIGS. 4 and 5. The learning processing unit 152 acquires teacher data from the teacher data table 143. The learning processing unit 152 calculates a sequence characteristic vector for each primary structure of the sequence information based on the first vector dictionary 142a. The learning processing unit 152 generates a character string of a Postscript program from a plurality of pieces of coordinate information included in the coordinate information, and calculates each three-dimensional coordinate vector based on the second vector dictionary 142b.

The learning processing unit 152 inputs sets of sequence characteristic vectors and three-dimensional coordinate vectors to the machine learning model M1, and updates the parameters of the machine learning model M1 on the basis of an error back propagation method or the like so that the difference between the output result of the machine learning model M1 and the label is reduced. The learning processing unit 152 repeatedly executes the above process by using each teacher data stored in the teacher data table 143.

The description regarding the other processes executed by the learning processing unit 152 is the same as the description regarding the process of the learning phase described with reference to FIGS. 4 and 5.

The inference processing unit 153 executes the process of the inference phase described with reference to FIGS. 6 and 7. The inference processing unit 153 acquires the sequence information and coordinate information to be inferred from the external device or the input unit 120.

The inference processing unit 153 calculates the sequence characteristic vector for each primary structure of the sequence information by using the first vector dictionary 142a. The learning processing unit 152 generates a Postscript program from a plurality of pieces of coordinate information included in the coordinate information, and calculates each three-dimensional coordinate vector based on the second vector dictionary 142b.

The inference processing unit 153 inputs sets of the sequence characteristic vectors and the three-dimensional coordinate vectors to the machine learning model M1, in order from the top. The inference processing unit 153 acquires output results output from the machine learning model M1 when the last set of the sequence characteristic vector of the primary structure and the three-dimensional coordinate vector of the coordinate information is input to the machine learning model M1.

When the score of the output result is equal to or greater than the threshold (combining OK), the inference processing unit 153 estimates that a receptor indicated in sequence information to be estimated and combined with a ligand is appropriate (the sequence of the series of primary structures of the receptor is also appropriate). On the other hand, when the score of the output result is less than the threshold (combining NG), the inference processing unit 153 estimates that the receptor indicated in the sequence information to be estimated and combined with the ligand is not appropriate.

The inference processing unit 153 outputs estimation results to the display unit 130 for display.

The description regarding the other processes executed by the inference processing unit 153 is the same as the description regarding the process of the inference phase described with reference to FIGS. 6 and 7.

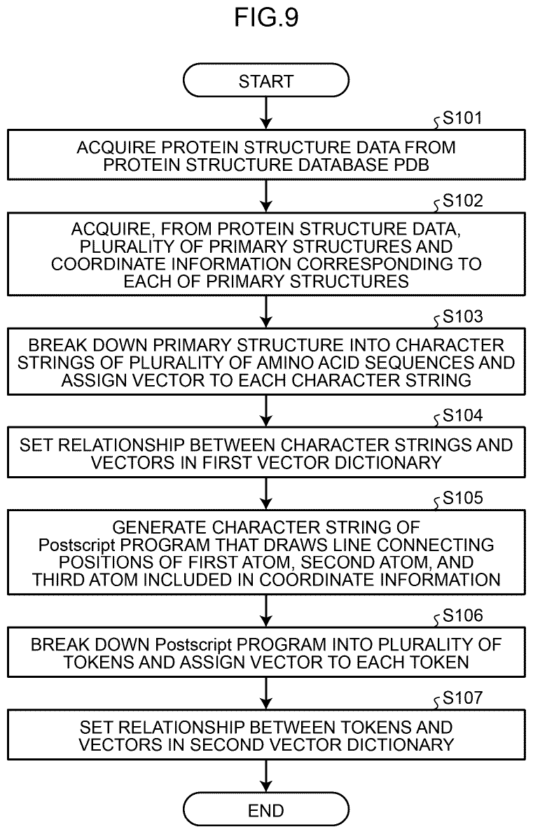

An example of the processing procedure of the information processing apparatus 100 according to the present embodiment is described below. FIG. 9 is a flowchart illustrating the processing procedure of the preprocessing phase. As illustrated in FIG. 9, the preprocessing unit 151 of the information processing apparatus 100 acquires protein structure data from the protein structure database PDB 141 (step S101). The preprocessing unit 151 acquires, from the protein structure data, a plurality of primary structures and coordinate information corresponding to each of the primary structures (step S102).

The preprocessing unit 151 breaks down the primary structure into character strings in a plurality of reference units, and assigns a vector to each character string (step S103). The preprocessing unit 151 sets the relationship between the character strings and the vectors in the first vector dictionary 142a (step S104).

The preprocessing unit 151 generates a Postscript program that draws the shape of a line connecting the positions of a first atom, a second atom, and a third atom included in the coordinate information (step S105). The preprocessing unit 151 breaks down the character string of the Postscript program into a plurality of tokens, and assigns a vector to each token (step S106).

The preprocessing unit 151 sets the relationship between the tokens and the vectors in the second vector dictionary 142b (step S107).

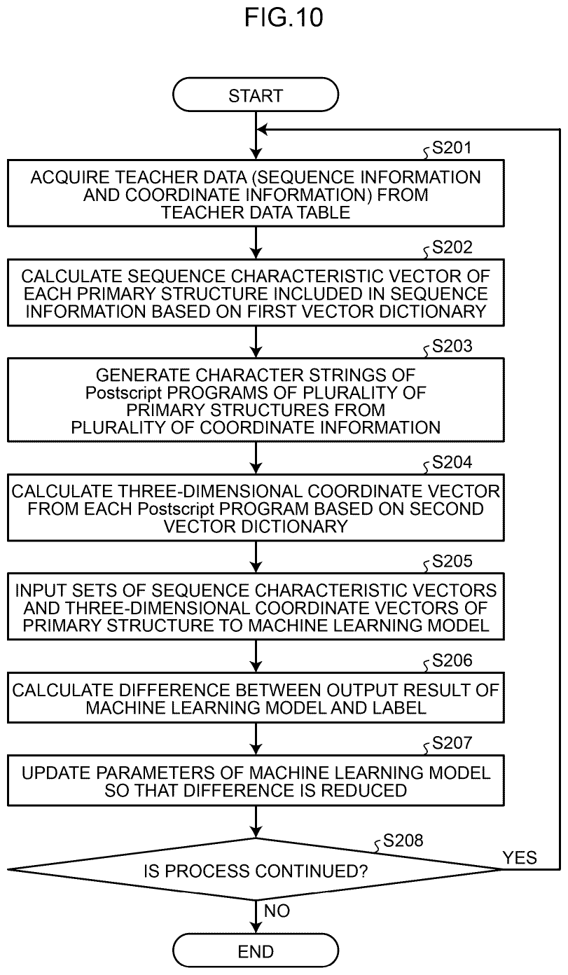

FIG. 10 is a flowchart illustrating the processing procedure of the learning phase. As illustrated in FIG. 10, the learning processing unit 152 of the information processing apparatus 100 acquires teacher data (sequence information and coordinate information) from the teacher data table 143 (step S201). The learning processing unit 152 calculates the sequence characteristic vector of each primary structure included in the sequence information based on the first vector dictionary 142a (step S202).

The learning processing unit 152 generates character strings of a plurality of Postscript programs from a plurality of pieces of coordinate information (step S203). The learning processing unit 152 calculates a three-dimensional coordinate vector from each Postscript program based on the second vector dictionary 142b (step S204).

The learning processing unit 152 inputs sets of the sequence characteristic vectors and the three-dimensional coordinate vectors to the machine learning model M1 (step S205). The learning processing unit 152 calculates the difference between an output result of the machine learning model M1 and a label (step S206).

The learning processing unit 152 updates parameters of the machine learning model M1 so that the difference is reduced (step S207). When the process is continued (Yes at step S208), the learning processing unit 152 proceeds to step S201. On the other hand, when the process is not continued (No at step S208), the learning processing unit 152 terminates the process.

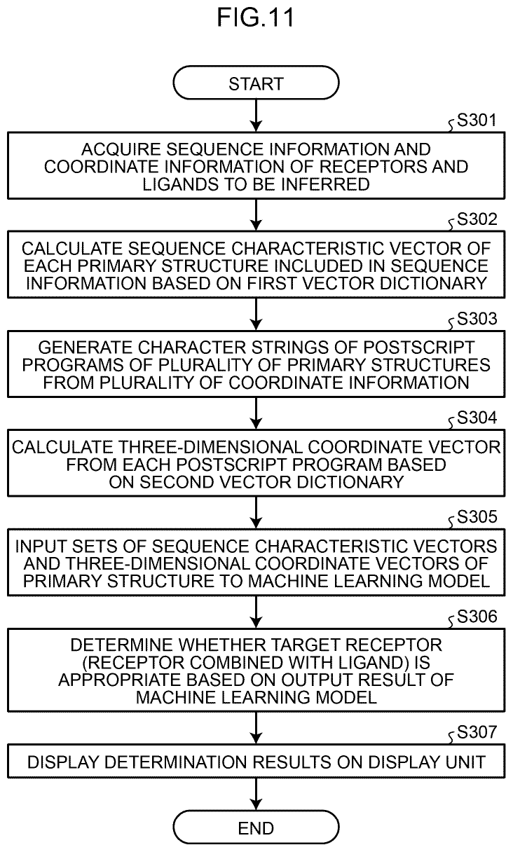

FIG. 11 is a flowchart illustrating the processing procedure of the inference phase. As illustrated in FIG. 11, the inference processing unit 153 of the information processing apparatus 100 acquires sequence information and coordinate information of receptors and ligands to be inferred from the input unit 120 (step S301). The inference processing unit 153 calculates the sequence characteristic vector of each primary structure included in the sequence information based on the first vector dictionary 142a (step S302).

The inference processing unit 153 generates a plurality of Postscript programs from a plurality of pieces of coordinate information (step S303). The inference processing unit 153 calculates a three-dimensional coordinate vector from each Postscript program based on the second vector dictionary 142b (step S304).

The inference processing unit 153 inputs sets of the sequence characteristic vectors of the primary structure and the three-dimensional coordinate vectors to the machine learning model M1 (step S305). Based on output results of the machine learning model M1, the inference processing unit 153 determines whether a target receptor (receptor combined with a ligand) is appropriate (step S306). The inference processing unit 153 displays determination results on the display unit 130 (step S307).

Effects of the information processing apparatus 100 according to the present embodiment are described below. In the learning phase, the information processing apparatus 100 trains the machine learning model M1 by using teaching data in which input data including sequence information of a plurality of primary structures and coordinate information of the primary structures and correct answer labels are associated with each other, the plurality of primary structures being included in a higher-order structure of a receptor combined with a ligand. In the combined state, which primary structures, which constitute the higher-order structure of the receptor, are adjacent before and after the primary structure of the ligand can be identified. This allows the generation of the machine learning model M1 to appropriately estimate whether the target receptor and ligand can be combined with each other.

The information processing apparatus 100 inputs sets of primary structures and coordinate information corresponding to the primary structures in order to the machine learning model M1, and executes machine learning of the machine learning model M1 so that the difference between output results of the machine learning model M1 and labels is reduced. This allows for the generation of the machine learning model M1 to not only appropriately estimate whether target receptor and ligand can be combined with each other, but also whether the sequence of primary structures of the receptor combined with the ligand is appropriate.

The information processing apparatus 100 generates coordinate information based on the positions of given atoms included in a plurality of primary structures. This allows the generation of the machine-learning model M1 to estimate whether the sequence of primary structures of a receptor combined with a ligand is appropriate by using both the sequence of the primary structures and the positions of the atoms.

The information processing apparatus 100 generates coordinate information by converting, into a vector, the character string of a PostScript program that draws a line segment connecting the positions of given atoms included in a plurality of primary structures. This allows the positions of the given atoms to be treated as vectors, and machine learning on the machine learning model M1 can be efficiently executed.

The information processing apparatus 100 generates sequence information by converting a primary structure into a vector based on a dictionary in which character strings in basic units of proteins and vectors are associated with each other. This allows the primary structure to be treated as a vector, and machine learning on the machine learning model M1 can be efficiently executed.

In the inference phase, the information processing apparatus 100 inputs input data including sequence information of a plurality of primary structures and coordinate information of the primary structures to the trained machine learning model M1, the plurality of primary structures being included in a higher-order structure of a target receptor (receptor combined with a ligand). This allows appropriate estimation of whether target receptor and ligand can be combined with each other.

The information processing apparatus 100 inputs sets of primary structures and coordinate information corresponding to the primary structures in order to the trained machine learning model M1 to obtain the output results of the machine learning model M1. This allows not only appropriate estimation of whether target receptor and ligand can be combined with each other, but also whether the sequence of primary structures of the receptor combined with the ligand is appropriate.

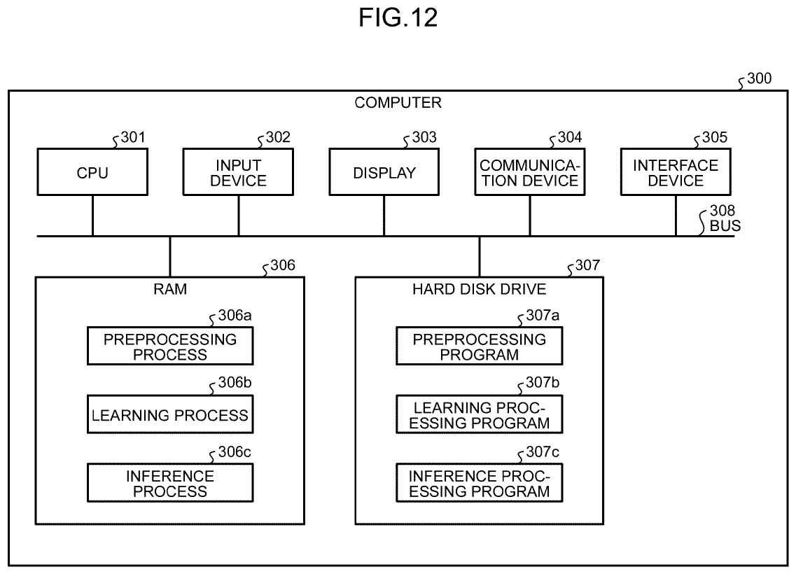

An example of a hardware configuration of a computer that implements the same functions as the information processing apparatus 100 described in the above embodiment is described below. FIG. 12 is a diagram illustrating an example of the hardware configuration of the computer that implements the same functions as the information processing apparatus of the embodiment.

As illustrated in FIG. 12, a computer 300 includes a CPU 301 that executes various arithmetic operations, an input device 302 that receives data from a user, and a display 303. The computer 300 also includes a communication device 304 that transmits and receives data to and from the external device or the like via a wired or wireless network, and an interface device 305. The computer 300 also includes a RAM 306 for temporarily storing various information and a hard disk drive 307. Each of the devices 301 to 307 is connected to a bus 308.

The hard disk drive 307 includes a preprocessing program 307a, a learning processing program 307b, and an inference processing program 307c. The CPU 301 also reads the programs 307a to 307c and loads the read programs on the RAM 306.

The preprocessing program 307a functions as a preprocessing process 306a. The learning processing program 307b functions as a learning process 306b. The inference processing program 307c functions as an inference process 306c.

A process of the preprocessing process 306a corresponds to the process of the preprocessing unit 151. A process of the learning process 306b corresponds to the process of the learning processing unit 152. A process of the inference process 306c corresponds to the process of the inference processing unit 153.

Each of the programs 307a to 307c does not necessarily have to be stored in the hard disk drive 307 from the beginning. For example, each program is stored on a “portable physical medium” such as a flexible disk (FD), a CD-ROM, a DVD, a magneto-optical disk, or an IC card that is inserted into the computer 300. Subsequently, the computer 300 may read and execute each of the programs 307a to 307c.

Whether target receptor and ligand can be combined with each other can be appropriately estimated.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A non-transitory computer-readable recording medium having stored therein a learning program that causes a computer to execute a process comprising:
acquiring teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other; and
executing machine learning of a machine learning model based on the teacher data.

2. The non-transitory computer-readable recording medium according to claim 1, wherein
the higher-order structure of the input data includes a primary structure of the ligand and a plurality of primary structures other than the primary structure of the ligand, and
the process further includes, in the process of executing the machine learning, inputting sets of the primary structures and the structure information to the machine learning model in order, and executing the machine learning of the machine learning model so that a difference between an output result of the machine learning model and the label is reduced.

3. The non-transitory computer-readable recording medium according to claim 1, wherein the process further includes generating the structure information based on positions of given atoms included in the primary structure.

4. The non-transitory computer-readable recording medium according to claim 2, wherein the process further includes converting, into a vector, a character string of PostScript that draws a line segment connecting positions of given atoms included in the primary structure.

5. The non-transitory computer-readable recording medium according to claim 1, wherein the process further includes converting the primary structure into a vector by dividing the primary structure into character strings of amino acid sequences of proteins and functional group sequences of organic compounds and by assigning the vector to each character string.

6. A non-transitory computer-readable recording medium having stored therein an inference program that causes a computer to execute a process comprising:
acquiring a plurality of target primary structures and a plurality of pieces of target structure information corresponding to the plurality of target primary structures, the plurality of target primary structures being included in a target higher-order structure of a target receptor to be inferred, the target receptor being combined with a target ligand; and
inferring whether the target receptor is appropriate by inputting the plurality of target primary structures and the plurality of pieces of target structure information to a machine learning model subjected to machine learning based on teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other.

7. The non-transitory computer-readable recording medium according to claim 6, wherein
the target higher-order structure includes a target primary structure of the target ligand and a plurality of target primary structures other than the target primary structure of the target ligand, and
the process further includes, in the process of inferring, inputting sets of the target primary structures and the target structure information to the machine learning model in order, and inferring whether the target receptor is appropriate based on an output result of the machine learning model.

8. A learning method comprising:
acquiring teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other; and
executing machine learning of a machine learning model based on the teacher data, by using a processor.

9. The learning method according to claim 8, wherein
the higher-order structure of the input data includes a primary structure of the ligand and a plurality of primary structures other than the primary structure of the ligand, and the learning method further includes
in the process of executing the machine learning, inputting sets of the primary structures and the structure information to the machine learning model in order, and executing the machine learning of the machine learning model so that a difference between an output result of the machine learning model and the label is reduced.

10. The learning method according to claim 8, further including generating the structure information based on positions of given atoms included in the primary structure.

11. The learning method according to claim 9, further including converting, into a vector, a character string of PostScript that draws a line segment connecting positions of given atoms included in the primary structure.

12. The learning method according to claim 8, further including converting the primary structure into a vector by dividing the primary structure into character strings of amino acid sequences of proteins and functional group sequences of organic compounds and by assigning the vector to each character string.

13. An inference method comprising:
acquiring a plurality of target primary structures and a plurality of pieces of target structure information corresponding to the plurality of target primary structures, the plurality of target primary structures being included in a target higher-order structure of a target receptor to be inferred, the target receptor being combined with a target ligand; and
inferring whether the target receptor is appropriate by inputting the plurality of target primary structures and the plurality of pieces of target structure information to a machine learning model subjected to machine learning based on teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other, by using a processor.

14. The inference method according to claim 13, wherein
the target higher-order structure further includes a target primary structure of the target ligand and a plurality of target primary structures other than the target primary structure of the target ligand, and the inference method includes
in the process of inferring, inputting sets of the target primary structures and the target structure information to the machine learning model in order, and inferring whether the target receptor is appropriate based on an output result of the machine learning model.

15. An information processing apparatus comprising:
a memory; and
a processor coupled to the memory and configured to:
acquire teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other; and
execute machine learning of a machine learning model based on the teacher data.

16. The information processing apparatus according to claim 15, wherein
the higher-order structure of the input data includes a primary structure of the ligand and a plurality of primary structures other than the primary structure of the ligand, and
the processor is further configured to input sets of the primary structures and the structure information to the machine learning model in order, and execute the machine learning of the machine learning model so that a difference between an output result of the machine learning model and the label is reduced.

17. The information processing apparatus according to claim 15, wherein the processor is further configured to generate the structure information based on positions of given atoms included in the primary structure.

18. The information processing apparatus according to claim 17, wherein the processor is further configured to convert, into a vector, a character string of PostScript that draws a line segment connecting positions of given atoms included in the primary structure.

19. The information processing apparatus according to claim 15, wherein the processor is further configured to convert the primary structure into a vector by dividing the primary structure into character strings of amino acid sequences of proteins and functional group sequences of organic compounds and by assigning the vector to each character string.

20. An information processing apparatus comprising:
a memory; and
a processor coupled to the memory and configured to:
acquire a plurality of target primary structures and a plurality of pieces of target structure information corresponding to the plurality of target primary structures, the plurality of target primary structures being included in a target higher-order structure of a target receptor to be inferred, the target receptor being combined with a target ligand; and
infer whether the target receptor is appropriate by inputting the plurality of target primary structures and the plurality of pieces of target structure information to a machine learning model subjected to machine learning based on teacher data associating input data including a plurality of primary structures and structure information of the plurality of primary structures with labels, the plurality of primary structures being included in a higher-order structure of a receptor combined with a ligand, the label indicating whether the receptor and the ligand are combinable with each other.

21. The information processing apparatus according to claim 20, wherein
the target higher-order structure includes a target primary structure of the target ligand and a plurality of target primary structures other than the target primary structure of the target ligand, and
the processor is further configured to input sets of the target primary structures and the target structure information to the machine learning model in order, and infer whether the target receptor is appropriate based on an output result of the machine learning model.
